(19) United States
(12) Patent Application Publication
(10) Pub. No.: US 2026/0134558 A1
(43) Pub. Date: May 14, 2026

(54) DEPTH MAP GENERATION SYSTEM, DEPTH MAP GENERATION METHOD, AND INFORMATION STORAGE MEDIUM

(71) Applicant: Japan Display Inc., Tokyo (JP)

(72) Inventors: Hirondo NAKATOGAWA, Tokyo (JP); Yoshiro AOKI, Tokyo (JP); Hitoshi TANAKA, Tokyo (JP)

(73) Assignee: Japan Display Inc., Tokyo (JP)

(21) Appl. No.: 19/383,835

(22) Filed: Nov. 10, 2025

(30) Foreign Application Priority Data
Nov. 14, 2024 (JP) 2024-199036

(51) Int. Cl. G06T 7/55; G03B 9/07; H04N 23/95

(52) U.S. Cl. CPC G06T 7/55; G03B 9/07; H04N 23/95; G06T 2207/20216

(57) ABSTRACT

A depth map generation system generates a depth map based on a plurality of captured images acquired by using an imaging device including a diaphragm unit in which a coded aperture is formed by a liquid crystal panel. The plurality of captured images including at least a first frame, a second frame acquired after acquisition of the first frame, and a third frame acquired after acquisition of the second frame. The depth map generation system includes: a combination unit configured to acquire a combined frame based on the first frame and the third frame; and a depth map generation unit configured to generate a depth map based on the combined frame and the second frame.

### CROSS-REFERENCE TO RELATED APPLICATION

The present application claims priority from Japanese patent application JP 2024-199036 filed on Nov. 14, 2024, the contents of which are hereby incorporated by reference into this application.

### BACKGROUND

### 1. Field

The present invention relates to a depth map generation system, a depth map generation method, and an information storage medium.

### 2. Description of the Related Art

C. Zhou, S. Lin, and S. Nayar: Coded Aperture Pairs for Depth from Defocus and Defocus Deblurring, IEEE international conference on computer vision, 2009 (hereinafter referred to as NPL 1) proposes a technique of generating a depth map from an image captured through a coded aperture. In the literature, two types of coded apertures having different aperture patterns (shapes of a light-transmitting region and a light-shielding region) are used.

In NPL 1, a depth is calculated as follows. (1) A PSF having a size corresponding to a predefined reference depth such as 100 mm or 300 mm and corresponding to the aperture pattern of the coded aperture is prepared. (2) A restored image is generated for each of a plurality of reference depths using the two captured images acquired through the two coded apertures respectively and the PSF. (3) A deviation between a gradation value of each pixel of the captured image and a gradation value of each pixel of the restored image is calculated, and the reference depth corresponding to the PSF that can obtain a small deviation is calculated as the depth information of each pixel in which a subject is displayed.

In the technique proposed in NPL 1, it is necessary to image an imaging target twice using two types of coded apertures. However, when the imaging target moves, a position and range of a region where the blur is observed change, and it is difficult to generate a depth map.

### SUMMARY

The invention has been made in view of such circumstances, and an object of the invention is to provide a depth map generation system and a depth map generation method capable of generating, even when an imaging target moves, a depth map while reducing an influence of the movement, and an information storage medium.

In order to solve the above-described problem, a depth map generation system according to the present application is a depth map generation system that generates a depth map based on a plurality of captured images acquired by using an imaging device including a diaphragm unit in which a coded aperture is formed, the plurality of captured images including at least a first frame, a second frame acquired after acquisition of the first frame, and a third frame acquired after acquisition of the second frame, and the depth map generation system includes: a combination unit configured to acquire a combined frame based on the first frame and the third frame; and a depth map generation unit configured to generate a depth map based on the combined frame and the second frame.

In addition, in order to solve the above-described problem, a depth map generation method according to the present application is a depth map generation method for generating a depth map based on a plurality of captured images acquired by using an imaging device including a diaphragm unit in which a coded aperture is formed, the plurality of captured images including at least a first frame, a second frame acquired after acquisition of the first frame, and a third frame acquired after acquisition of the second frame, and the depth map generation method includes: acquiring a combined frame based on the first frame and the third frame; and generating a depth map based on the combined frame and the second frame.

In addition, in order to solve the above problem, a program stored in a non-transitory information storage medium according to the present application is a program for generating a depth map based on a plurality of captured images acquired by using an imaging device having a diaphragm unit in which a coded aperture is formed, the plurality of captured images including at least a first frame, a second frame acquired after acquisition of the first frame, and a third frame acquired after acquisition of the second frame, and the program causes a computer to function as: a combination unit configured to acquire a combined frame based on the first frame and the third frame; and a depth map generation unit configured to generate a depth map based on the combined frame and the second frame.

### BRIEF DESCRIPTION OF THE DRAWINGS

FIG. 1 is a diagram schematically showing a depth map generation system according to a present embodiment;

FIG. 2 is a diagram showing an example of aperture patterns of coded apertures;

FIG. 3 is a functional block diagram showing an example of functions implemented by a control unit according to the present embodiment;

FIG. 4 shows an example of a frame and an aperture pattern of a coded aperture used for generating a depth map;

FIG. 5 is a diagram schematically showing gradations in three consecutive frames;

FIG. 6 is a diagram schematically showing a gradation in a combined frame;

FIG. 7 is a diagram schematically showing gradations in a frame used for generating a depth map; and

FIG. 8 is a flowchart of a depth map generation process according to the present embodiment.

### DETAILED DESCRIPTION

In the present application, in order to make a description clearer, a width, a thickness, a shape, and the like of each part may be schematically represented in the drawings as compared with actual aspects, but they are merely examples and do not limit the interpretation of the invention. In the specification and drawings, components having the same functions as those described in connection with preceding drawings are denoted by the same reference numerals, and a repetitive description thereof is omitted unless necessary.

### Outline

As disclosed in NPL 1, in a system using a coded imaging method, depth information related to an imaging target can be acquired by observing a blur in a captured image. The depth information is information related to a distance of the imaging target with respect to an imaging element, and is information used for generating a depth map. The depth map is an image in which a depth in the captured image is expressed by shading. The blur in the captured image is observed in a boundary region where pixel values of respective pixels change. For example, the boundary region is a region in which pixel values in a group of adjacent pixels rapidly change. Specifically, for example, the blur in the captured image is observed in a boundary region between an outer edge of the imaging target and a background thereof. Note that, here, the pixel value is a value related to a brightness (luminance) or a color in each pixel.

In addition, as proposed in NPL 1 described above, in a method using two types of coded apertures, it is necessary to image an imaging target twice using the two types of coded apertures, respectively. By using the two types of coded apertures having different aperture patterns, it is possible to determine whether the imaging target is in front of or behind an in-focus point (in-focus position), and acquisition accuracy of the depth information is improved.

However, when the imaging target moves, a position of the boundary region changes, and a position and range of the blur change accordingly. In particular, when the imaging target moves at a high speed, the position and range of the blur greatly change in a short time, and a ranging calculation becomes difficult.

Therefore, a depth map generation system 100 according to the present embodiment employs a configuration capable of generating, even when the imaging target moves, a depth map while reducing an influence of the movement. Specifically, in the depth map generation system 100, a combined frame F13 is generated based on a first frame F1 and a third frame F3, and the depth map is generated based on the combined frame F13 and a second frame F2. Here, the first frame F1 is an image acquired at a time t1, the second frame F2 is an image acquired at a time t2 (>t1), and the third frame F3 is an image acquired at a time t3 (>t2). Note that, each interval between the times t1, t2, and t3 may be several hundred milliseconds or several tens of milliseconds. Hereinafter, details of the depth map generation system 100 will be described.

### Overall Configuration of Depth Map Generation System

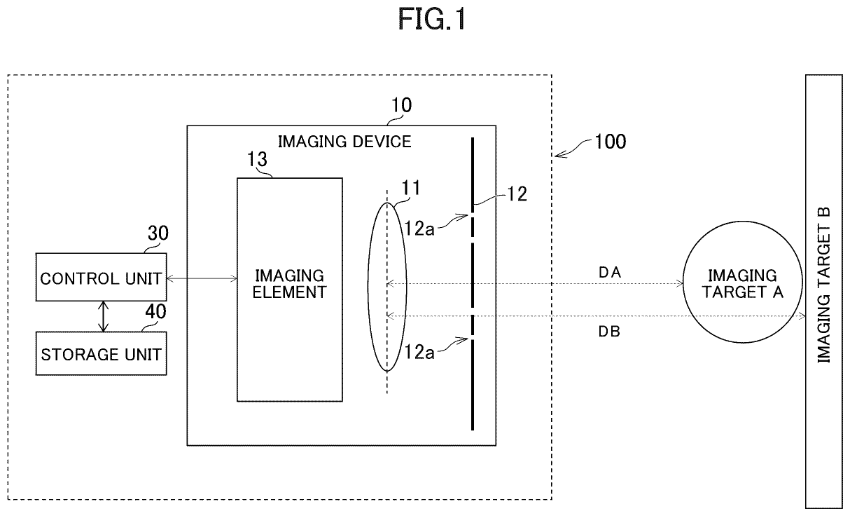

First, an overview of an overall configuration of the depth map generation system 100 according to the present embodiment will be described with reference to FIG. 1. FIG. 1 is a schematic diagram schematically showing the depth map generation system according to the present embodiment.

The depth map generation system 100 includes at least an imaging device 10, a control unit 30, and a storage unit 40.

FIG. 1 schematically shows a state in which the depth map generation system 100 acquires an image in which an imaging target A whose distance from the depth map generation system 100 is DA and an imaging target B (here, a background) whose distance from the depth map generation system 100 is DB are displayed. Note that, the distance DA may be a distance from a surface of the imaging target A to a center of a lens 11, and the distance DB may be a distance from a surface of the imaging target B to the center of the lens 11.

The imaging device 10 is a camera capable of acquiring a distance in a depth direction of an imaging target using a coded imaging method for observing a blur. The imaging device 10 may be a digital camera or a camera built in a smartphone or the like. The imaging device 10 may be, for example, a camera capable of capturing a moving image having a frame rate of 60 f/s.

The imaging device 10 includes an optical system including at least one lens 11, a diaphragm unit 12 in which coded apertures 12a that narrow external light passing through the optical system with aperture patterns are formed, and an imaging element 13. Note that, the imaging device 10 is not limited to the configuration shown in FIG. 1, and may have various configurations mounted on a general camera to implement an imaging function. For example, the imaging device 10 may include a shutter or the like that adjusts an exposure amount of external light to the imaging element 13.

The lens 11 may be a lens used in a general camera, and may have a configuration capable of adjusting a focal distance. Note that, although FIG. 1 schematically shows one lens 11, the optical system may include a plurality of lens groups. The diaphragm unit 12 may be a liquid crystal panel. The coded aperture 12a may be formed by the liquid crystal panel.

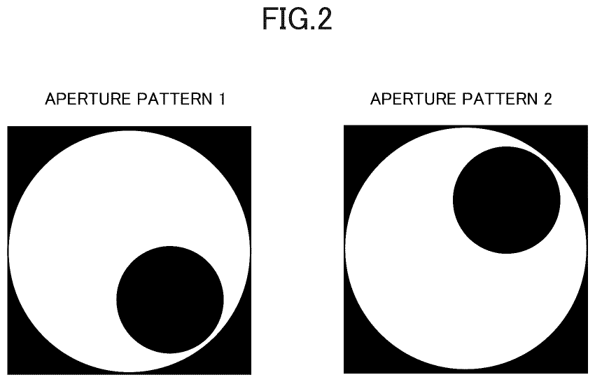

FIG. 2 is a diagram showing an example of aperture patterns of coded apertures by the liquid crystal panel. FIG. 2 shows two different types of aperture patterns. In FIG. 2, a black region corresponds to a light-shielding region, and a white region corresponds to a light-transmitting region.

The diaphragm unit 12 partially blocks external light incident on the lens 11. The coded apertures 12a are formed in the diaphragm unit 12. In the depth map generation system 100, the diaphragm unit 12 in which the coded apertures 12a are formed is used as a diaphragm (coded diaphragm), and a method referred to as depth from defocus (DFD) is used in which a depth of a scene is estimated from a blur of an image by controlling a point spread function (hereinafter, also simply referred to as a PSF) and frequency characteristics thereof. The PSF is a function also called a blur function.

The diaphragm unit 12 may be a liquid crystal panel or a liquid crystal shutter, and may have a configuration capable of changing an aperture pattern of the coded aperture 12a. In the present embodiment, an example in which the aperture pattern is alternately switched for each frame will be described.

The imaging element 13 may be a complementary metal oxide semiconductor (CMOS) sensor or a charge-coupled device (CCD) used in a general camera. The image detected by the imaging element 13 may be a color image or a monochrome image.

The control unit 30 includes at least one processor. The control unit 30 processes image data obtained by the imaging element 13 to acquire depth information of the imaging target shown in the captured image. The control unit 30 may be capable of acquiring the depth information of each of the plurality of pixels of the imaging element 13 by a restoration process based on the blur function related to the aperture pattern of the coded aperture 12a of the diaphragm unit 12. In addition, the control unit 30 may drive the liquid crystal of the coded aperture 12a so as to switch the aperture pattern.

The storage unit 40 includes a main storage unit and an auxiliary storage unit. For example, the main storage unit is a volatile memory such as a random access memory (RAM), and the auxiliary storage unit is a non-volatile memory such as a read only memory (ROM), an electrically erasable and programmable read only memory (EEPROM), a flash memory, or a hard disk.

### Functions Implemented by Depth Map Generation System

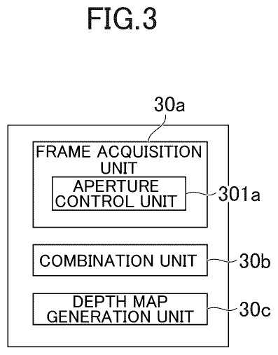

FIG. 3 is a functional block diagram showing an example of functions implemented by the depth map generation system according to the present embodiment. Each function shown in FIG. 3 is implemented by a computer executing programs stored in the storage unit 40. The programs may be stored in a computer-readable information recording medium.

In the depth map generation system 100, a frame acquisition unit 30a, a combination unit 30b, and a depth map generation unit 30c are implemented. These functions may be implemented mainly by the control unit 30.

The frame acquisition unit 30a acquires each frame of a moving image captured by the imaging device 10. The frame acquisition unit 30a further includes an aperture control unit 301a. The aperture control unit 301a controls the liquid crystal of the coded aperture 12a so as to form a predefined aperture pattern. The aperture control unit 301a sequentially switches the plurality of aperture patterns in synchronization with light reception by the imaging element 13.

Based on the two captured frames, the combination unit 30b generates and acquires a combined frame by averaging pixel values of the two frames. The depth map generation unit 30c generates a depth map using the combined frame acquired by the combination unit 30b. Note that, the depth map generation unit 30c generates the depth map based on two imaging frames by using the method disclosed in NPL 1 described above, but a description of a specific generation process will be omitted.

### Example of Generation of Depth Map

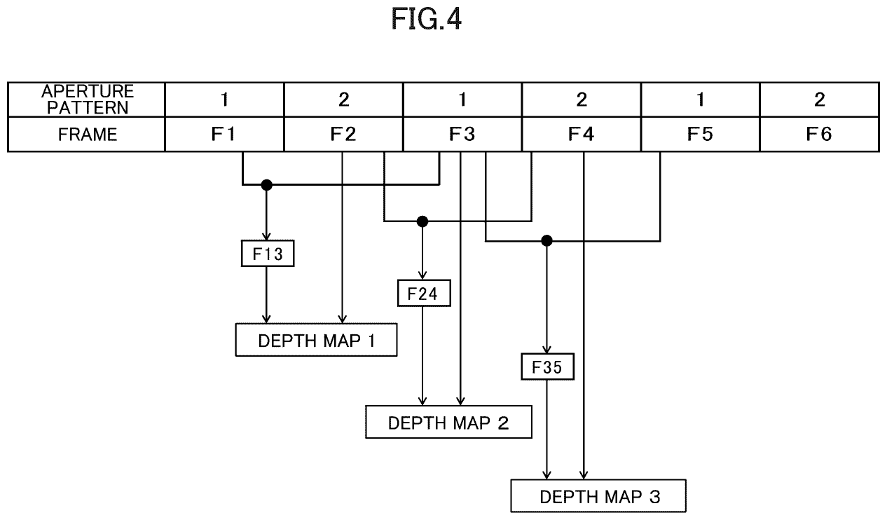

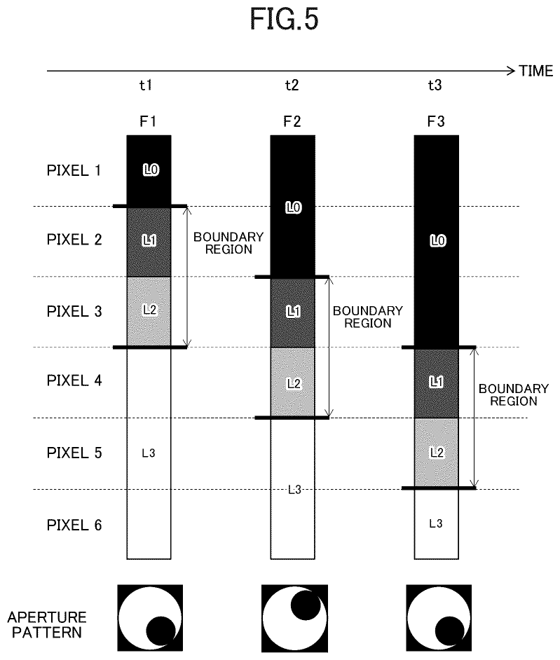

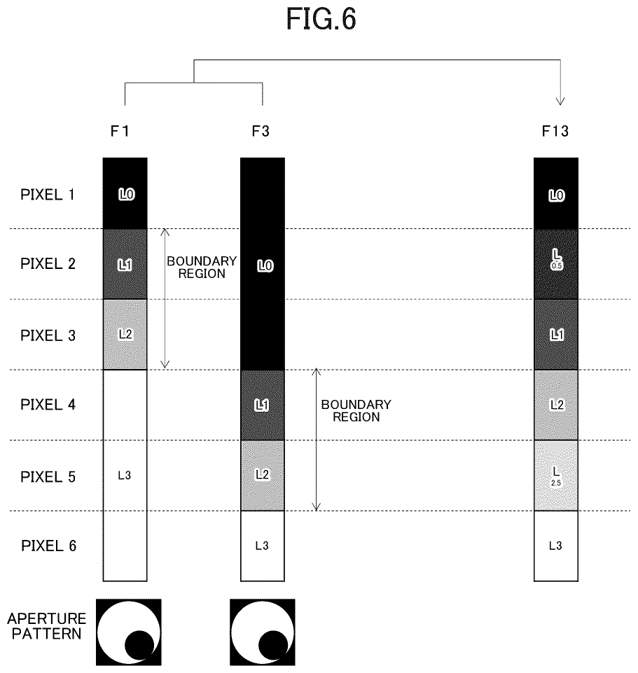

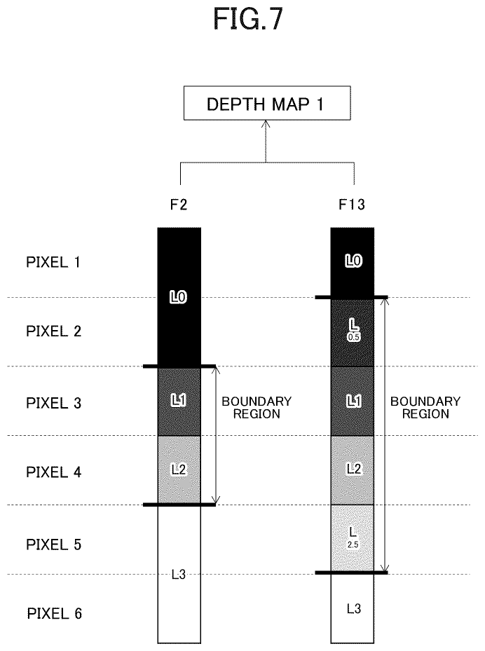

An example of generation of a depth map according to the present embodiment will be described with reference to FIGS. 4 to 7. FIG. 4 shows an example of a frame and an aperture pattern of a coded aperture used for generating a depth map. FIG. 5 is a diagram schematically showing gradations in three consecutive frames. FIG. 6 is a diagram schematically showing a gradation in a combined frame. FIG. 7 is a diagram schematically showing gradations in a frame used for generating a depth map.

First, the frame acquisition unit 30a acquires a captured image (frame) indicating an imaging target. In the present embodiment, as shown in FIG. 4, the aperture pattern of the coded aperture 12a is switched for each frame. Specifically, a common aperture pattern 1 is used in the frames F1, F3, and F5, and a common aperture pattern 2 is used in the frames F2, F4, and F6.

Here, “L” in FIGS. 5 to 7 indicates a luminance of each pixel. The larger the number following “L”, the higher the luminance. In FIG. 5, a pixel region with a low luminance is a region in which the imaging target is represented, and a pixel region with a high luminance is a region in which a background of the imaging target is represented. That is, FIG. 5 shows a state in which the imaging target approaches the imaging element 13 with passage of time, and thus a region having a low luminance is enlarged. Note that, although FIGS. 5 to 7 show a schematic example in which a plurality of pixels are arranged in a vertical direction, the pixels may be arranged in a grid pattern in the vertical direction and a horizontal direction.

FIG. 5 shows a region in which a gradation changes stepwise. This region is a boundary region between an outer edge of the imaging target and the background, and is a region in which a blur is observed. Specifically, pixels 2 and 3 correspond to the boundary region in the frame F1, pixels 3 and 4 correspond to the boundary region in the frame F2, and pixels 4 and 5 correspond to the boundary region in the frame F3.

In the present embodiment, the combination unit 30b combines the frame F1 and the frame F3. Specifically, the combined frame F13 is generated by averaging the pixel values of the pixels of the frame F1 and the pixel values of the pixels of the frame F3, respectively. For example, FIG. 6 shows an example in which an average of a luminance L1 of the pixel 2 of the frame F1 and a luminance L0 of the pixel 2 of the frame F3 is calculated to generate the combined frame F13 having a luminance L0.5 of the pixel 2.

As shown in FIG. 7, the boundary region in the frame F2 and the boundary region in the combined frame F13 appear in pixels overlapping each other. That is, the position and range of the blur overlap between the frame F1 and the combined frame F13. By using the frame F1 and the combined frame F13 as described above, even when the imaging target moves, the depth map can be generated while reducing an influence of displacement of the boundary region due to the movement.

### Flowchart

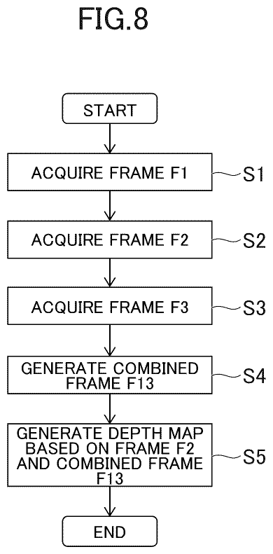

FIG. 8 is a diagram showing a flowchart of a depth map generation process according to the present embodiment. The control unit 30 sequentially acquires the frames F1 to F3 (S1 to S3). Next, the control unit 30 generates the combined frame F13 based on the frame F1 and the frame F3 (S4). Then, the control unit 30 generates a depth map based on the frame F2 and the combined frame F13 (S5). Note that, the process shown in FIG. 8 is a process corresponding to a process of generating a depth map 1 shown in FIG. 4, but a depth map 2 and the subsequent depth maps may be generated by the same process. By sequentially generating the depth maps in this manner, a dynamic depth map can be generated.

### SUMMARY

In the present embodiment described above, it is possible to generate the depth map while reducing the influence of the movement of the imaging target, as compared with a case where the depth map is generated based on two consecutive frames (for example, the frame F1 and the frame F2). As a result, it is possible to generate a depth map with high accuracy even when the imaging target moves.

In the present embodiment, the example in which the depth map is generated using three temporally consecutive frames is described. By using a plurality of frames acquired in a short time in this manner, it is possible to reduce the influence of the movement of the imaging target. However, the invention is not limited thereto, and the frame F1, the frame F2, and the frame F3 may be frames that are acquired in a discontinuous and discrete manner, or may not be frames acquired at equal time intervals.

In the present embodiment, the example in which the combined frame F13 is generated by calculating the average value of the pixel values of the pixels of the frame F1 and the pixel values of the pixels of the frame F3 is described, but the invention is not limited thereto. For example, the pixel values of the pixels of the combined frame F13 may be calculated from the pixel values of the pixels of the frame F1 and the pixel values of the pixels of the frame F3 using a predetermined function. The predetermined function may include a parameter related to an imaging environment such as a temperature.

What is claimed is:

1. A depth map generation system that generates a depth map based on a plurality of captured images acquired by using an imaging device including a diaphragm unit in which a coded aperture is formed by a liquid crystal panel, the plurality of captured images including at least a first frame, a second frame acquired after acquisition of the first frame, and a third frame acquired after acquisition of the second frame, the depth map generation system comprising:
a combination unit configured to acquire a combined frame based on the first frame and the third frame; and
a depth map generation unit configured to generate a depth map based on the combined frame and the second frame.

2. The depth map generation system according to claim 1, wherein
the diaphragm unit is a liquid crystal panel in which the coded aperture is formed such that an aperture pattern is switchable, and
the first frame and the third frame are images captured using the coded aperture having a common aperture pattern.

3. The depth map generation system according to claim 1, wherein
the combination unit generates the combined frame by averaging a pixel value of each pixel of the first frame and a pixel value of each pixel of the third frame corresponding to each pixel of the first frame.

4. A depth map generation method for generating a depth map based on a plurality of captured images acquired by using an imaging device including a diaphragm unit in which a coded aperture is formed by a liquid crystal panel, the plurality of captured images including at least a first frame, a second frame acquired after acquisition of the first frame, and a third frame acquired after acquisition of the second frame, the depth map generation method comprising:
acquiring a combined frame based on the first frame and the third frame; and
generating a depth map based on the combined frame and the second frame.

5. A non-transitory information storage medium storing a program for generating a depth map based on a plurality of captured images acquired by using an imaging device including a diaphragm unit in which a coded aperture is formed by a liquid crystal panel, the plurality of captured images including at least a first frame, a second frame acquired after acquisition of the first frame, and a third frame acquired after acquisition of the second frame, the program causing a computer to function as:
a combination unit configured to acquire a combined frame based on the first frame and the third frame; and
a depth map generation unit configured to generate a depth map based on the combined frame and the second frame.
